(19) United States
(12) Patent Application Publication
(10) Pub. No.: US 2018/0093210 A1
(43) Pub. Date: Apr. 5, 2018

(54) DISK FILTER AND METHOD FOR THE MANUFACTURE THEREOF

(71) Applicant: Robert Bosch GmbH, Stuttgart (DE)

(72) Inventors: Dietmar Schmieder, Markgroeningen (DE); Andreas Jakobi, Schwieberdingen (DE); Henning Kreschel, Ludwigsburg (DE); Martin Mueller, Moeglingen (DE); Thomas Sebastian, Charleston, SC (US); Tilo Landenfeld, Vailhingen/Enz (DE); Wolfgang Stoecklein, Waiblingen (DE)

(21) Appl. No.: 15/564,584

(22) PCT Filed: Apr. 20, 2016
(86) PCT No.: PCT/EP2016/058750

§ 371 Date: Oct. 5, 2017

(30) Foreign Application Priority Data
Apr. 27, 2015 (DE) 10 2015 207 686.5

(51) Int. Cl. B01D 29/46; B01D 29/11

(52) U.S. Cl. CPC B01D 29/46; B01D 29/111

(57) ABSTRACT

A filter, including a plurality of annularly closed disks having a through-opening. The disks include at least one contact area projecting from a lateral surface for a contact with an adjoining disk, and radial flow-through areas adjoining the contact area, and the disks being situated as a disk stack.

### BACKGROUND INFORMATION

The present invention relates to a disk filter, including a plurality of annular disks having a through-opening, to a component, in particular a fuel-conducting component, including a filter according to the present invention, and to a method for manufacturing the filter.

Filters are used, for example, as fuel filters in vehicles. Usually, metallic filter fabrics are provided with a plastic overmold and used as filters. However, large tolerances with respect to a mesh size of the filter result during the manufacture of such filters. Moreover, the manufacture of such filters is very cost-intensive. Another problem of today's filters is that, due to the increasing use of biofuels, more particles are present in the fuel, which at times have very small dimensions of less than 15 μm and are impossible to filter out completely using today's filters. When using biofuels, it is also possible for deposits to arise when mixed with oil or the like, which may clog or destroy the filters. These then cause deposits and possibly clogs in downstream components, in particular injectors, which may cause failure of the injector. Furthermore, a disk-shaped fuel filter is described in German Patent Application No. DE 10208569 A1, which is clamped between two bodies of an injector and includes a plurality of fine cuts created with the aid of laser. As a result of the creation of the cuts with the aid of a laser, however, a minimal cutting width of 15 μm is possible for principle-related matters due to the use of the laser. However, it is therefore not possible to completely filter out the minute particles present in biofuels.

### SUMMARY

An example filter according to the present invention may have the advantage that a manufacture of the filter is very cost-effective and possible as a mass-produced component. In this way, the costs for such filters, in particular fuel filters, which are mass-produced components, may be significantly reduced. Furthermore, with the aid of the filter according to the present invention, considerably improved filtering of media, in particular fuels, may be enabled, it being possible to filter in particular biofuels in such a way that a vehicle may also be operated, for example, with 100% ethanol or another biofuel. Of course, the filter according to the present invention is also able to filter out small fragments or the like stemming from the manufacturing process of other fuel-conducting components. This is achieved according to the present invention in that the filter includes a plurality of annularly closed disks, each having a through-opening. The disks are designed in such a way that at least one projecting contact area for a contact with an adjoining disk and at least one radial flow-through area, adjoining the contact area, are provided on a disk surface. The disks are situated as a disk stack and form the filter. The medium thus flows via the radial flow-through areas in the radial direction between two adjoining disks from an outer side of the disks to an inner side, or from an inner side of the disks to an outer side of the disks. Due to the arrangement of the disk stacks, the filter thus has a hollow basic shape, in particular a hollow cylinder shape. The filtering takes place by the passages between adjoining disks which are formed between the disks via the radial flow-through areas.

Preferred refinements of the present invention are described herein.

Preferably, a closed terminating disk is situated on one end of the disk stack. In this way, a cover or bottom of the disk stack is formed, so that filtering from the outside to the inside or from the inside to the outside is easily implemented.

Further preferably, all disks of the disk stack are fixedly joined to one another. In this way, simple handling, in particular secure installation of the filter may be enabled.

The disks are preferably joined to one another with the aid of a joint extending in the axial direction of the disk stack. The joint is preferably a welded joint, in particular a resistance welded joint, or an adhesive joint or a soldered joint or a press-fit joint or a flared joint.

The joint of the disks is preferably provided on an outer circumference of the disk stack and/or is provided on an inner circumference of the disk stack.

According to one further preferred embodiment of the present invention, the filter includes a preloading element which preloads the disk stack. The preloading element is preferably a spring element or a preloading sleeve.

Further preferably, the filter includes a gimbal mount on a free end of the disk stack. The gimbal mount is preferably formed by an additional element, which has a tapering area provided as a bearing area. The tapering area is preferably conical.

Further preferably, the filter includes a sealing element, which is situated on at least one of the free ends of the disk stack. Particularly preferably, two sealing elements are provided, a respective sealing element being situated on a free end of the disk stack.

According to one further preferred embodiment of the present invention, the filter includes a press-fit element, in particular a press-fit ring, which is provided for fixing the filter, in particular in a borehole or the like. The press-fit element is particularly preferably provided on a free end of the disk stack.

To enable an alignment of the individual disks of the disk stack prior to joining or the like, each of the disks preferably includes an alignment area. The alignment area is preferably a projecting nose or the like. The projecting nose may project on the outer circumference and/or a projecting nose is provided on the inner circumference of the disk stack.

Instead of a nose, of course also a recess may be provided as the alignment area of the disks.

To make a manufacture of the projecting contact areas and of the radial flow-through areas preferably cost-effective and simple, a respective projecting contact area and at least one radial flow-through area are preferably provided on each disk on the lateral surface and a lateral undersurface. By stacking the disks, the passages between the disks are thus formed by radial flow-through areas formed on the two adjoining disks.

Further preferably, each disk has inflow grooves and outflow grooves on a disk surface and/or a lateral undersurface. This facilitates a flow through the clearance between the disks and both during the inflow through the clearance and during the outflow from the clearance.

Further preferably, the disks are stamped parts or EMC parts, which are manufactured with the aid of electrochemical machining. Further alternatively, the contact areas on the disk surface are applied by coating, e.g., chrome-plating. Further alternatively, the disks are electropolished parts, the radial flow-through areas being created with the aid of electropolishing.

A height of the projecting areas of the disks is preferably in a range of 1/10 to 1/20 of a thickness of the disk. The height of the projecting areas is preferably in a range of 5 μm to 30 μm, in particular 10 μm to 20 μm, and particularly preferably is 10 μm.

According to a further preferred embodiment of the present invention, the projecting contact areas of the disks are situated on a line which is in parallel to a center axis of the disk stack.

For an installation in the proper location, each of the disks preferably has at least three inwardly and/or outwardly projecting alignment areas for a centering in an opening, in particular a borehole or the like.

The filter according to the present invention is preferably provided as a fuel filter.

Furthermore, the present invention relates to a component which includes a filter according to the present invention. The component is preferably a fuel-conducting component and in particular provided for vehicles. For example, the component is an injector or a rail or a fuel pump.

The present invention furthermore relates to a method for manufacturing a filter, including the steps of providing a plurality of annularly closed disks and of stacking the plurality of disks to form a disk stack to provide a filter. Preferably, an axial preloading of the disk stack takes place.

Further preferably, a joining of the individual disks of the disk stack takes place, in particular in the axial direction along an outer circumference of the disk stack and/or an inner circumference of the disk stack. The joining may take place with the aid of welding and/or gluing and/or soldering and/or with the aid of a press-fit joint and/or with the aid of a flared joint.

Further preferably, an alignment of the disks to form the disk stack takes place. The alignment particularly preferably takes place prior to the joining of the disks.

Further preferably, radial flow-through areas are generated on a surface of the disks by pressing or electropolishing or electrochemical machining. Further preferably, projecting contact areas for a contact with adjoining disks or adjoining projecting contact areas are generated by applying material to a disk surface or alternative coating, e.g., chrome-plating of portions of the disk surface.

Further preferably, a last closed terminating disk is situated on the disk stack without a hole, after creation of the disk stack, in order to form a cover or a bottom of the disk stack.

The present invention is to be used particularly preferably for fuel-conducting components, in particular in the automotive field.

### BRIEF DESCRIPTION OF THE DRAWINGS

Preferred exemplary embodiments of the present invention are described hereafter in greater detail with reference to the figures. Identical or functionally equivalent parts are denoted by the same reference numerals.

FIG. 1 shows a schematic sectional view of a filter according to the present invention according to a first exemplary embodiment of the present invention.

FIG. 2 shows a schematic, enlarged view of the filter from FIG. 1.

FIG. 3 shows a schematic top view onto a disk surface of a disk of the filter from FIG. 1.

FIG. 4 shows an enlarged sectional view of a disk of the filter from FIG. 1.

FIG. 5 shows a schematic sectional view of an installation state of the filter from FIG. 1.

FIG. 6 shows a schematic, perspective view of a spring element for preloading the filter.

FIG. 7 shows a perspective view of the filter from FIG. 1.

FIG. 8 shows a schematic sectional view of a filter according to a second exemplary embodiment of the present invention in the installed state.

FIG. 9 shows a schematic top view onto a disk of a filter according to a third exemplary embodiment of the present invention.

FIG. 10 shows a schematic sectional view of the disk from FIG. 9.

FIG. 11 shows a schematic sectional view of a filter according to a fourth exemplary embodiment in the installed state.

FIG. 12 shows a schematic sectional view of a filter according to a fifth exemplary embodiment of the present invention.

FIG. 13 shows a schematic view of a disk surface of a filter according to a sixth exemplary embodiment.

FIG. 14 shows a schematic sectional view of a filter in the installed state according to a seventh exemplary embodiment of the present invention.

### DETAILED DESCRIPTION OF EXAMPLE EMBODIMENTS

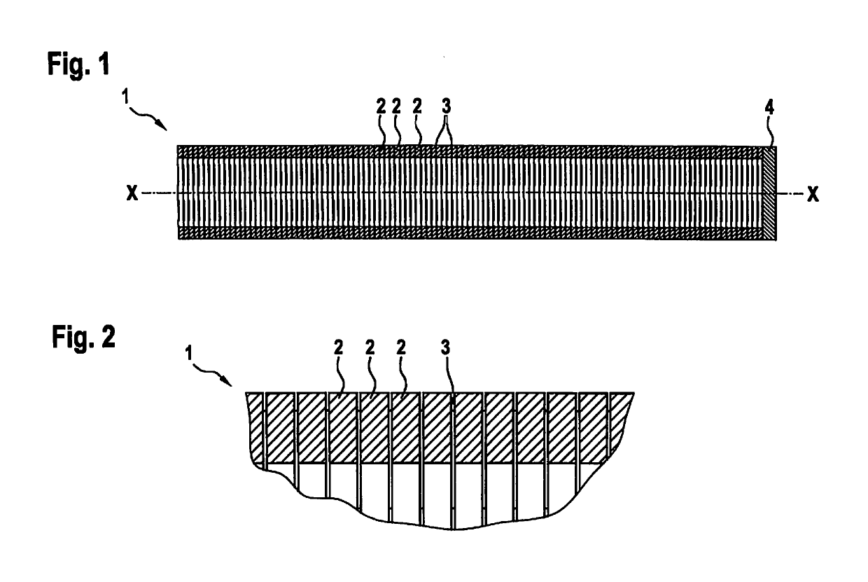

A filter 1 according to a first preferred exemplary embodiment of the present invention is described in greater detail hereafter with reference to FIGS. 1 through 7.

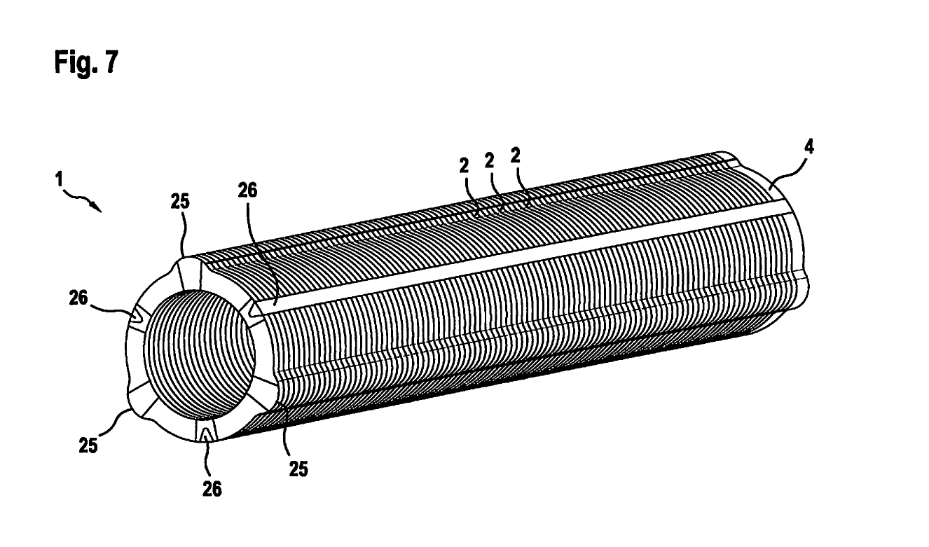

As is in particular apparent from the sectional view of FIG. 1, filter 1 includes a plurality of disks 2 which are situated on top of one another and form a disk stack. This is apparent in a perspective view from FIG. 7.

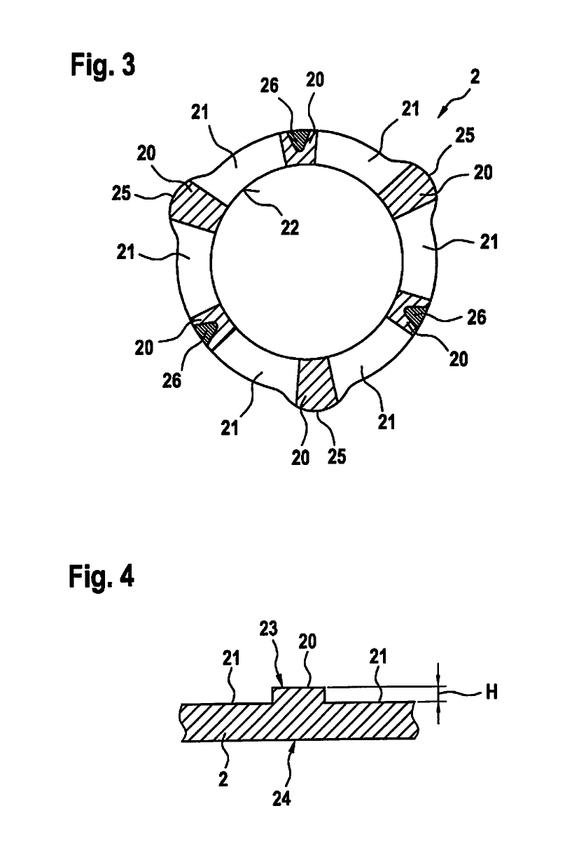

As is shown in FIG. 3, disks 2 are annularly closed disks and have a through-opening 22.

As is apparent from FIGS. 3 and 4, the disks have a disk surface 23 and a disk undersurface 24. Multiple projecting contact areas 20 are provided on disk surface 23. As is apparent from the sectional view of FIG. 4, a height H of the contact areas relative to a radial flow-through area of disk 2 is in a range of 10 μm.

In this exemplary embodiment, six contact areas 20 are provided on disk surface 23. Correspondingly six radial flow-through areas 21 are also provided. As is apparent in particular from FIG. 4, no projecting areas are provided on disk undersurface 24, so that lateral undersurface 24 is planar.

As explained above, disks 2 are situated to form a disk stack, three alignment areas 25 being provided on each disk for alignment. Alignment areas 25 are formed on the outer circumference of each disk 2 and are provided as radially outwardly projecting areas. A transition to the disk circumference is provided as a continuous transition. On joining areas 26, which in this exemplary embodiment are weld seams, disks 2 are furthermore joined to one another in axial direction X-X on the outer circumference of the disk stack.

As becomes coherent in particular from FIGS. 2 and 4, a respective gap 3 is provided between adjoining disks 2 due to the stacking of disks 2 to form a disk stack. Gap 3 has a respective width corresponding to height H of contact area 20 since disk undersurface 24 of disks 2 is planar.

The filter thus provided may be manufactured with the aid of different methods. For example, in a first step, disks 2 may be stamped from a sheet metal material and subsequently radial flow-through areas 21 may be generated, for example with the aid of pressing or electrochemical machining (EMC) or electropolishing. As an alternative or in addition, it would also be conceivable that contact areas 20 are generated by partial coating of the disk surface. In this way, it is possible to create very small heights H in the range up to 5 μm, so that a very good filter performance is achieved by the filter according to the present invention.

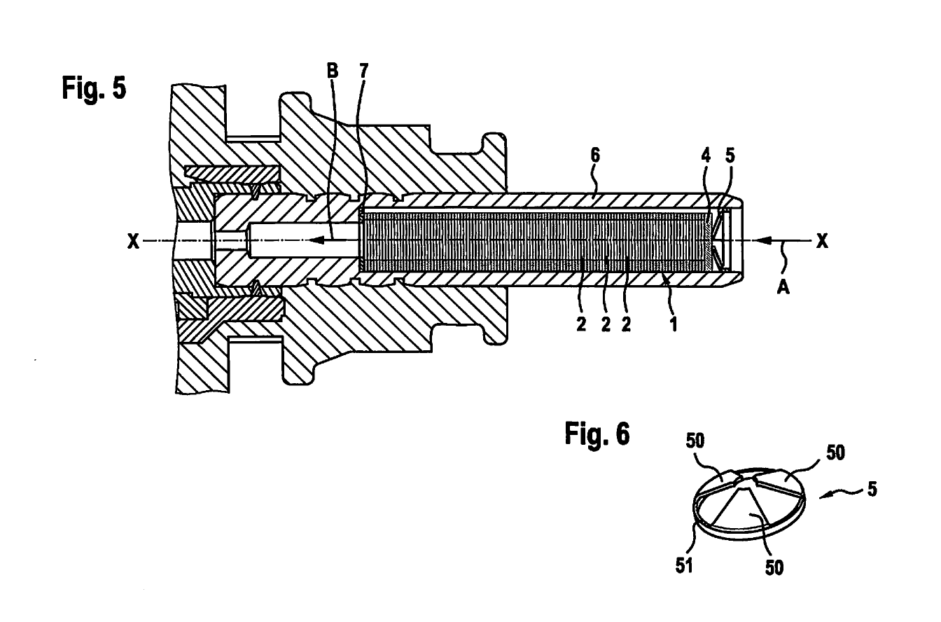

FIG. 5 shows the installation of filter 1 according to the present invention in a cylinder component 6 of an injector for fuel. A borehole diameter of cylinder component 6 is larger than a maximum outside diameter of filter 1. Filter 1 is held in cylinder component 6 under preload with the aid of a spring element 5 (see FIG. 6). Reference numeral 7 denotes a sealing ring, which seals the outer circumference of filter 1 with respect to cylinder component 6.

Filter 1 is held in cylinder component 6 under preload with the aid of spring element 5. Spring element 5 is shown in detail in FIG. 6. Spring element 5 includes three inwardly directed spring noses 50, which generate the preload. Spring element 5 is pressed with a peripheral edge 51 into the borehole in cylinder component 6. In this way, a sufficient preload may be exerted on filter 1.

As shown in FIG. 5, fuel now flows corresponding to arrow A through spring element 5 toward the outer circumference of filter 1, which is closed with the aid of a closed terminating disk 4 against which spring element 5 rests. The fuel thus flows from the outer circumference of filter 1 through gap 3 between disks 2 to the inner circumference and from there, corresponding to arrow B, to the injector.

Due to the small gap height of gap 3, it is thus possible with the aid of filter 1 according to the present invention to filter appropriate particles from the fuel even in the case of biofuels. Furthermore, partial lifts of the valve up to approximately 20 μm with a full lift of approximately 35 μm may be carried out, without clogging occurring as a result of particles on the valve seat.

It shall furthermore be noted that, as becomes apparent from FIG. 5, filter 1 does not necessarily have to be welded together with the aid of joining areas 26, but that disks 2 could also be loosely stacked as a result of the preload with the aid of filter element 5 in cylinder component 6 and then be pressed against one another by fixation of spring element 5. This, however, has assembly-related disadvantages, so that a filter 1 present as an installation part, which is joined by weld seams or the like, is easier to install.

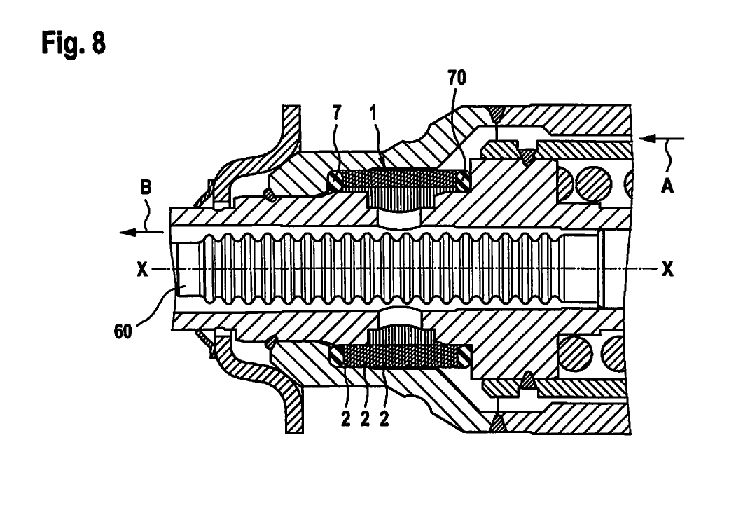

FIG. 8 shows a filter 1 according to a second exemplary embodiment of the present invention. Filter 2 of the second exemplary embodiment is formed completely as a hollow cylinder. As the installation situation in an injector in FIG. 8 shows, filter 1 furthermore includes a first sealing element 7 and a second sealing element 70. First sealing element 7 is situated on a first end of filter 1, and second sealing element 70 on a second end. The fuel is supplied corresponding to arrow A to the outer circumference of filter 1, then flows through radial flow-through areas 21 between disks 2 to the inner area of filter 1 and from there, corresponding to arrow B, to a tip of a valve needle 60 (not shown in detail). Filter 1 thus does not include a closed terminating disk, but is situated between two components of a fuel-conducting element with the aid of two sealing elements.

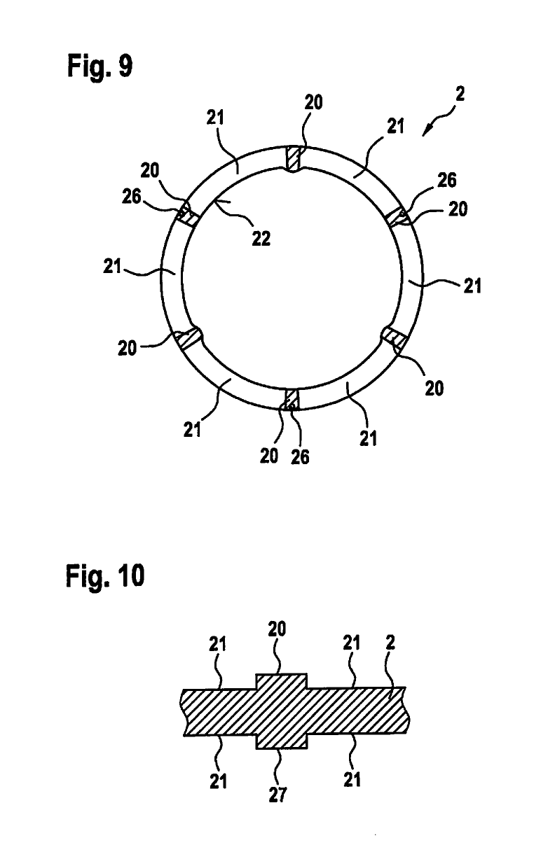

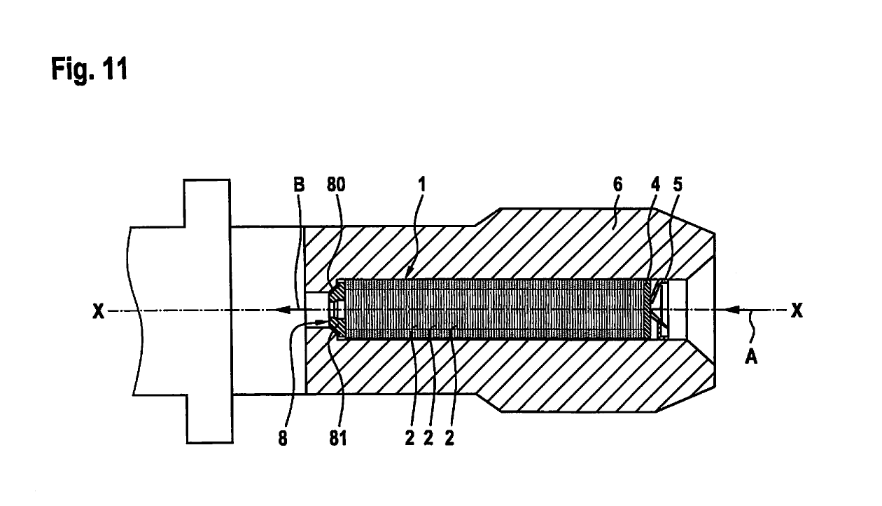

FIGS. 9 and 10 show a disk 2 of a filter according to a third exemplary embodiment of the present invention. As is apparent in particular from FIG. 10, disk 2 of the filter of the third exemplary embodiment includes first projecting contact areas 20 on a disk surface 23, and second projecting contact areas 27 on a disk undersurface 24. In the disk stack, respective projecting contact areas 20 or 27 of the adjoining disk then rest against one another, so that the gaps between the disks are formed. Alternatively, the disks may also be situated in such a way that a respective contact area rests against a radial flow-through area 21, so that the contact areas are each offset in the circumferential direction of disks 2.

FIG. 11 shows a filter 1 according to a fourth exemplary embodiment of the present invention. Filter 1 corresponds to that of the first exemplary embodiment, closed terminating disk 4 being situated on a first end of filter 1, and a gimbal mount 8 being provided on a second end of filter 1. The gimbal mount is provided by a conical area 80 of a termination component 81. Prior to the final fixation of filter 1, it will be inserted into cylinder component 6 and aligned coaxially to center axis X-X with the aid of gimbal mount 8, e.g., also when manufacturing-related component tolerances occur, and then fixed with the aid of spring element 5.

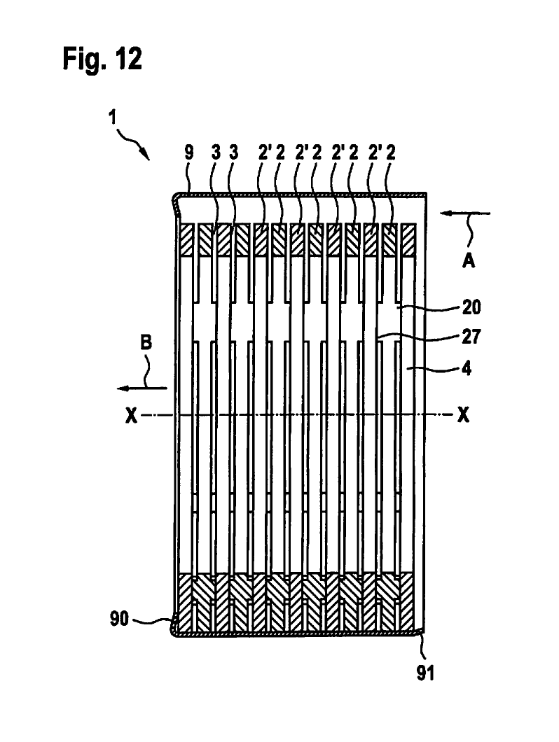

FIG. 12 shows a filter 1 according to a fifth exemplary embodiment of the present invention. Filter 1 of fifth exemplary embodiment additionally includes a sleeve 9, which is provided as a joining element for joining the individual disks 2 stacked in the disk stack. Sleeve 9 includes a bent area 90 on a first end of the filter against which last disk 2 of the filter is supported. Furthermore, sleeve 9 includes a crimp area 91, which is crimped on the sleeve after the disk stack has been positioned and aligned in order to exert an appropriate preload on disks 2. As is furthermore apparent from FIG. 12, disks 2 of this exemplary embodiment are not all designed the same. Disks 2 of the filter include first disks, as shown in FIG. 10, having a first and a second projecting contact area 20, 27 and, adjoining thereon, a flat disk 2′ having no projecting areas. Disks 2, 2′ are alternately arranged so that the distance between disks 2, 2′ is the same. This creates the small gaps 3 between neighboring disks, which are responsible for the filter action.

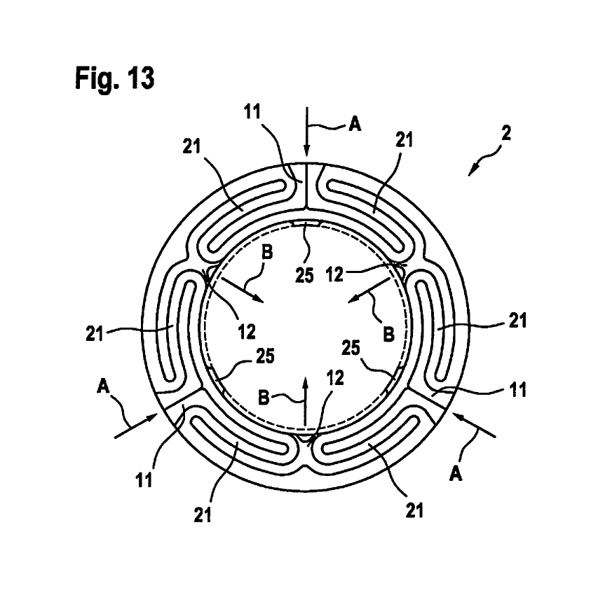

FIG. 13 shows a filter 1 according to a sixth exemplary embodiment of the present invention. Three inflow grooves 11 and three outflow grooves 12 are formed in disk surface 23. The unfiltered fuel is supplied to inflow grooves 11 and is then conducted via radial flow-through areas 21 to outflow grooves 12, and from there into the interior of filter 1 (arrows B).

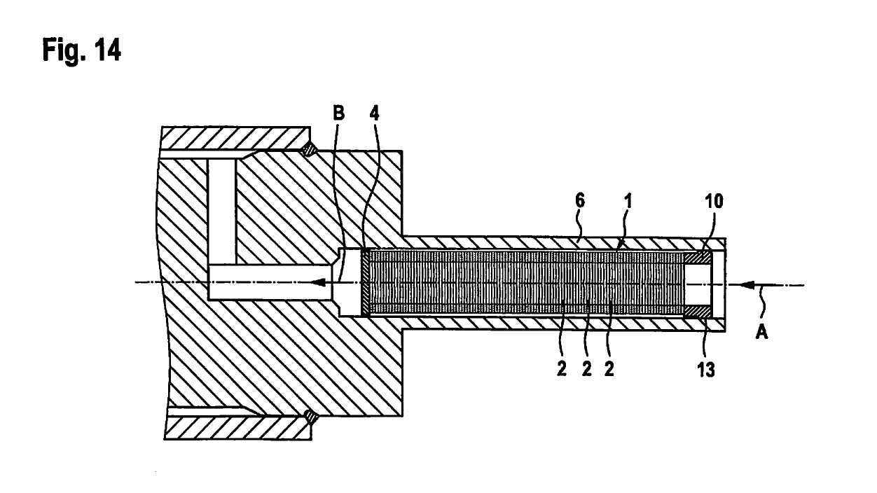

FIG. 14 shows a filter 1 according to a seventh exemplary embodiment of the present invention. Filter 1 of the seventh exemplary embodiment includes a press-fit ring 10, which is pressed into a borehole of a valve component 6 with the aid of a press-fit joint 13, on a free end of filter 1. Alternatively, welding, crimping, screening or soldering is also possible. As indicated by arrow A, fuel flows into the interior of filter 1 and via radial flow-through areas 21 radially from the inside to the outside. In this exemplary embodiment, the flow direction is thus opposite that of the preceding exemplary embodiments since the flow direction on filter 1 is provided to be from the inside to the outside. As indicated by arrow B, the fuel is then supplied to injection openings or the like. Press-fit ring 10 is preferably fixed together with disks 2 with the aid of the weld seam extending in the axial direction.

With regard to all described exemplary embodiments, the flow direction through the filter, i.e., from the outside to the inside or from the inside to the outside, may be selected corresponding to the particular conditions. The number of disks forming filter 1 is also provided as a function of the filter performance to be delivered. On the disks, alignment areas 25 may be formed on the inner circumference and/or on the outer circumference. Alignment areas 25 may also be used to center the filter in a borehole. The disks are preferably provided from a metal material and may in particular be manufactured by stamping and pressing. In this way, the filter according to the present invention may in particular be used for applications, e.g., E100, which include pure biofuel or large admixed amounts of biofuels. The production methods for manufacturing the disks allow smaller tolerances than were previously possible. In the case of injectors, it is furthermore possible that also smaller needle lifts, up to approximately 20 μm, may be carried out since the filters according to the present invention have a smaller gap size, in particular in the range of 10 μm. This does not result in a problem with only smaller needle lifts which are carried out in the partial load operation of an internal combustion engine, for example.

1-28. (canceled)

29. A filter, comprising:
a plurality of annularly closed disks having a through-opening, the disks including at least one contact area projecting from a lateral surface for a contact with an adjoining one of the disks, and radial flow-through areas adjoining the contact area, the disks being situated as a disk stack, the radial flow-through areas being formed by a distance between two adjoining disks, and the radial flow-through areas providing a filter action.

30. The filter as recited in claim 29, wherein a closed terminating disk is situated on one end of the disk stack.

31. The filter as recited in claim 29, wherein the disks are joined to one another on a joining area.

32. The filter as recited in claim 31, wherein the joining area of the disks extends in the axial direction of the disk stack.

33. The filter as recited in claim 32, wherein the disks are joined to one another with the aid of one of: (i) a welded joint, (ii) an adhesive joint, (iii) a soldered joint, (iv) a press-fit joint, or (v) a sleeve having a flared joint.

34. The filter as recited in claim 29, further comprising:
a preloading element which preloads the disk stack.

35. The filter as recited in claim 34, wherein the preloading element is one of a spring element or a preloading sleeve.

36. The filter as recited in claim 29, wherein a gimbal mount is provided on an axial end of the disk stack.

37. The filter as recited in claim 29, further comprising:
a sealing element which is situated on at least one axial end of the disk stack.

38. The filter as recited in claim 29, further comprising:
a press-fit element which is configured to fix the filter in a borehole.

39. The filter as recited in claim 29, wherein each of the disks includes at least one alignment area.

40. The filter as recited in claim 39, wherein, (i) the alignment area is at least one of an inwardly projecting nose and an outwardly projecting nose, or (ii) the alignment area is a recess provided on at least one of an inner circumference and the outer circumference.

41. The filter as recited in claim 29, wherein each of the disks includes a first projecting contact area on a disk surface, and a second projecting area on a disk undersurface.

42. The filter as recited in claim 29, wherein each of the disks includes inflow grooves and outflow grooves on at least one of a disk surface and a disk undersurface.

43. The filter as recited in claim 29, wherein the disks are one of: (i) stamped parts, (ii) EMC parts, (iii) coated parts in which the contact areas are created with the aid of coating, or (iv) electropolished parts in which the radial flow-through areas are created with the aid of electropolishing.

44. The filter as recited in claim 41, wherein a height of the projecting contact areas is in a range of 1/10 to 1/20 of a thickness of the disk.

45. The filter as recited in claim 41, wherein the projecting contact areas of the disks are situated on a line, which is in parallel to a center axis of the disk stack.

46. The filter as recited in claim 29, wherein each of the disks includes at least three inwardly and/or outwardly projecting alignment areas for a centering of the disk stack in a borehole.

47. The filter as recited in claim 29, wherein the filter is a fuel filter.

48. An assembly, including a filter, the filter comprising a plurality of annularly closed disks having a through-opening, the disks including at least one contact area projecting from a lateral surface for a contact with an adjoining one of the disks, and radial flow-through areas adjoining the contact area, the disks being situated as a disk stack, the radial flow-through areas being formed by a distance between two adjoining disks, and the radial flow-through areas providing a filter action.

49. The assembly as recited in claim 48, wherein the assembly is a fuel-conducting assembly.

50. The assembly as recited in claim 49, wherein the assembly is a valve or a rail or a fuel pump.

51. A method for manufacturing a filter, comprising:
providing a plurality of annularly closed disks including at least one projecting contact area and at least one radial flow-through area; and
stacking the plurality of disks to form a disk stack to provide a filter through which flow is possible in the radial direction of the disk stack.

52. The method as recited in claim 51, further comprising:
axially preloading the disk stack.

53. The method as recited in claim 51, further comprising:
joining the disks of the disk stack to one another on at least one joining area.

54. The method as recited in claim 53, wherein the joining of the disks takes place with the aid of at least one of: (i) welding on an outer circumference of the disk stack, (ii) welding on an inner circumference of the disk stack, (iii) gluing, (iv) soldering, (v) press-fit joining, and (vi) flare joining with the aid of a sleeve.

55. The method as recited in claim 51, wherein the radial flow-through areas between projecting contact areas are created by one of: (i) pressing, (ii) electrochemical machining, or (iii) electropolishing.

56. The method as recited in claim 51, wherein a closed terminating disk is situated on an axial end of the filter on a disk stack formed by the disks.
